(19) United States
(12) Patent Application Publication
(10) Pub. No.: US 2009/0282291 A1
(43) Pub. Date: Nov. 12, 2009

(54) INTERNAL MAINTENANCE ASSOCIATION END POINT (MEP) FOR SHARING STATE INFORMATION

(75) Inventors: Deborah Fitzgerald, Acton, MA (US); Piotr Romanus, Andover, MA (US); John Osswald, Northbridge, MA (US); Srikanth Keesara, Tewksbury, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: NORTEL NETWORKS LIMITED, St. Laurent (CA)

(21) Appl. No.: 12/262,200

(22) Filed: Oct. 31, 2008

Related U.S. Application Data
(60) Provisional application No. 61/051,600, filed on May 8, 2008.

(51) Int. Cl. G06F 11/22

(52) U.S. Cl. 714/39; 714/E11.152

(57) ABSTRACT

A network node includes a central processor card and a plurality of line cards. Each line card generates a maintenance association end point (MEP) entity that can respond to connectivity fault management (CFM) frames. The MEP entity on each line card periodically generates and transmits a multicast connectivity check message (CCM) to the other line cards in the network node. The CCM includes a card-information TLV and, optionally, a trunk-status TLV. Card-information TLVs include the slot number and card type of the transmitting line card. Trunk-status TLVs include the trunk state of each trunk supported by the transmitting line card. The line cards of the node consider a given line card to be down when three consecutive CCMs from that line card are missed. In response to recognizing a down line card, the other line cards can initiate an action, such as determine the trunks supported by the down line card and trigger a trunk switchover.

### RELATED APPLICATION

This utility application claims the benefit of U.S. Provisional Patent Application No. 61/051,600, filed on May 8, 2008, the entirety of which is incorporated by reference herein.

### FIELD OF THE INVENTION

The present invention relates generally to fault management. More particularly, the present invention relates to a system and method for implementing connectivity fault management mechanisms on line cards internally within a network node.

### BACKGROUND

The IEEE (Institute of Electrical and Electronics Engineers) organization has formalized a standards document for connection fault management, referred to as IEEE 802.1ag (also known as Connectivity Fault Management or CFM). In general, the IEEE 802.1ag standard specifies managed objects, protocols, and procedures for, among other things, detecting and diagnosing connectivity faults in end-to-end Ethernet networks. CFM mechanisms for fault detection include continuity check, linktrace (traceroute), loopback (ping), and alarm indication at different levels or domains (e.g., customer level, service provider level, and operator level).

The IEEE 802.1ag standard defines various CFM entities and concepts, including maintenance domains (MDs), maintenance associations (MAs), and maintenance association end points (MEPs). According to IEEE 802.1ag, a maintenance domain is “the network or the part of the network for which faults in connectivity can be managed”, a maintenance association is “a set of MEPs, each configured with the same MAID (maintenance association identifier) and MD Level, established to verify the integrity of a single service instance”, and a maintenance association end point is “an actively managed CFM entity” that “can generate and receive CFM PDUs” (protocol data units or frames). Additional details regarding such CFM entities are available in the IEEE 802.1ag/D8.1 draft standard, the entirety of which is incorporated by reference herein.

Fault management among cards in a network node is typically handled using a hello mechanism between a central processor (CP) card and the line cards of the node. A shortcoming of this hello mechanism is, however, that the CP card must constantly send letters to and receive letters from each line card to track the health of that line card. When one line card fails or is removed, a definite period of time elapses before the CP card realizes several hello messages have been missed. The CP card must then broadcast the loss of that particular line card to every other line card in the chassis. Only after the CP card has learned and broadcast the change in the health of the line card can the other line cards react. Often, the loss of a line card requires a failover of network traffic previously supported by that line card. To support specified failover times, it is important for line cards to learn of the state changes of other line cards in the chassis as quickly as possible so that the network node can respond within the guaranteed failover timeframe.

### SUMMARY

In one aspect, the invention features a network node for use in a communications network. The network node includes a central processor (CP) card, a switch fabric, and a plurality of line cards. Each line card is in communication with the CP card and with each other line card through the switch fabric. Each line card has a maintenance association end point (MEP) entity that responds to connectivity fault management (CFM) frames. The MEP entity of each line card is configured to generate and transmit a multicast connectivity check message (CCM) periodically to the other line cards in the network node through the switch fabric.

In another aspect, the invention features a method of communication among line cards in a network node. The method comprises generating, on each line card of a plurality of line cards in the network node, a maintenance association end point (MEP) entity that responds to connectivity fault management (CFM) frames. The MEP entity on each line card periodically generates and transmits a multicast connectivity check message (CCM) to the other line cards in the network node.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a simplified example of a network to which is coupled a network node constructed in accordance with invention.

FIG. 2 is a block diagram of one embodiment of the network node of FIG. 1.

FIG. 3 is a diagram of an embodiment of a process performed by each line card upon initialization and subsequent re-initialization.

FIG. 4 is a diagram of an embodiment of a card-information TLV.

FIG. 5 is a diagram of an embodiment of a trunk-status TLV.

FIG. 6 is a diagram of an example of a portion of a continuity check message having a card-information TLV and a plurality of fixed-length trunk-status TLVs.

FIG. 7 is a diagram of an example of a portion of a continuity check message having a card-information TLV and a variable-length trunk-status TLV.

FIG. 8 is a flow diagram of an embodiment of a process for sharing state information among line cards in the network node.

### DETAILED DESCRIPTION

A network node constructed in accordance with the present invention has a central processor (CP) card with a switch fabric and line cards, each of which instantiates an MEP. In contrast to the MEPs defined according to the IEEE 802.1ag standard, which reside in separate chassis (or boxes) and exchange continuity check messages (CCMs) externally over a network, the MEPs of the present invention exchange CCMs internally within the network node (i.e., within the box) using the internal switch fabric. Advantageously, the well-tested peering program code currently used between a pair of local and remote MEPs (in separate boxes) can be reused by the present invention to implement MEP communications between line cards of a single box.

Through the exchange of CCMs, the line cards of the network node internally share their state information. This internal exchange enables the CP card to forego the transmission of letters to all line cards because each line card in the network node is independently able to know the health of all other line cards from CCMs received. In addition, this internal communication reduces the time it takes for line cards to notice when another line card within the chassis has ceased to operate or has been removed. This reduced-time-to-recognition consequentially reduces the amount of time required to trigger a trunk switchover. Although described herein primarily with regard to triggering a trunk switchover, the use of internal MEPs to detect a lost line card can trigger other types of system responses.

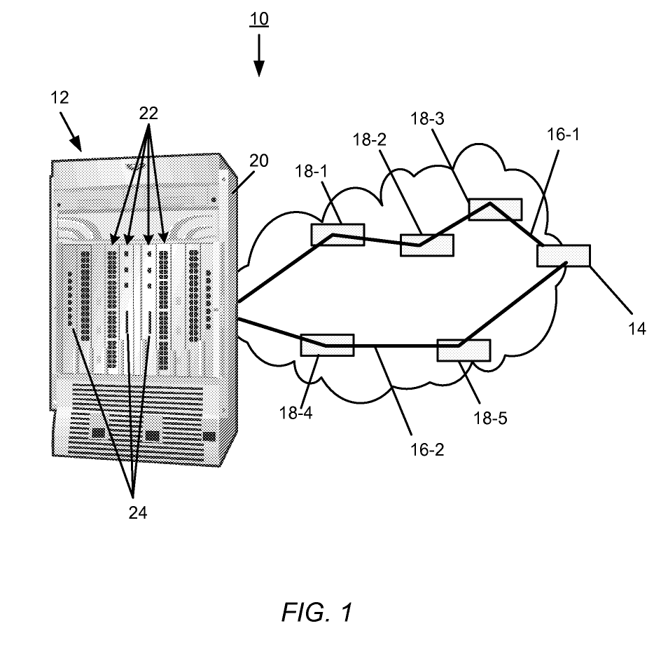

FIG. 1 shows a simplified example of a communications network 10 including a first network node (or device) 12 in communication with a second network node 14 over a plurality of data paths 16-1, 16-2 (also referred to generally as trunks 16). The data paths 16-1, 16-2 traverse different routes through the network 10. Here, for example, the data path 16-1 includes core routers 18-1, 18-2, and 18-3, whereas data path 16-2 includes core routers 18-4 and 18-5. The data paths 16-1, 16-2 belong to a trunk group in which one data path (e.g., 16-1) is the active or primary trunk and the other data path (e.g., 16-2) is the secondary trunk. In general, the primary trunk carries data between the first network node 12 and the second network node 14 unless the primary trunk goes down. In that event, the network nodes 12, 14 execute a trunk switchover so that the secondary trunk becomes the active trunk for carrying the packet traffic.

The network node 12 includes a chassis 20 with a plurality of numbered slots 22. Cards 24 reside in the numbered slots 22. Although shown here to be coupled to only two data paths, typically the cards 24 of the network node 12 are in communication over hundreds or thousands of such paths to a number of different destination nodes (such as network node 14).

In one embodiment, the communication network 10 is a metro-area Ethernet network, the network node 12 is the Metro Ethernet Routing Switch 8600, manufactured by Nortel Networks Limited of Toronto, Calif., and the data paths 16 are Ethernet-switched paths. A connection-oriented forwarding technology, called Provider Backbone Bridge Traffic Engineering or PBB-TE (draft standard IEEE 802.1Qay), can be used to establish the data paths. Through PBB-TE, service providers are able to establish point-to-point and point-to-multipoint Ethernet tunnels and to specify paths that the service traffic will take through their Ethernet networks.

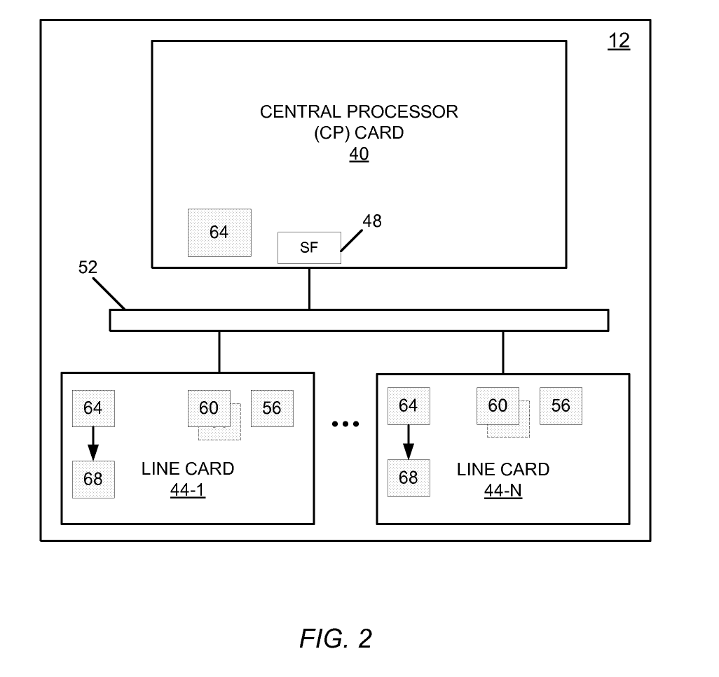

FIG. 2 shows an embodiment of the network node 12 of FIG. 1, as a representative example of network nodes constructed in accordance with the invention. The network node 12 includes a central processor (CP) card 40 and a plurality of input/output modules or interface modules, also called line cards 44-1, 44-n (generally, 44). Examples of types of line cards 44 include, but are not limited to, SFP-based, Gigabit Ethernet Services modules, 1000 BaseX for SFP modules, 10 Gigabit Ethernet XFP module, GBIC-based Gigabit Ethernet Services Module, POS Baseboard supports up to 6 OC-3 or 3 OC-12 ports, 1000 BASE-T, and fixed Gigabit Ethernet.

The CP card 40 includes a switch fabric (SF) 48 (e.g., an Ethernet switch) and communicates with the line cards 44 through a midplane (or backplane) 52. Although shown to be part of the CP card 40, the SF 48 can alternatively be embodied on the midplane 52. Each line card 44 has a co-processor (COP) 56 and one or more route switch processors (RSPs) 60 for processing packets. The number of RSPs on a given line card depends on the card type and number of ports on the line card. Each RSP maps to a different lane; for example, a line card with three RSPs has three different lanes. Each lane supports a number of trunks (e.g., 1504). Trunks are individually and uniquely indexed (i.e., identifiable) by a tuple comprising the slot number of the line card, the lane number, and an index identifier. In one embodiment, the CP card 40 generates the trunk indexes. Each line card 44 also has memory (not shown) that is used to store routing tables.

The COP 56, which is a general-purpose CPU for the line card, manages the routing tables on each RSP 60 and handles exceptions from each RSP 60. In general, the COPs 56 manage trunks and UNI (user-network interface) ports and exchange messages with each other.

The network node 12 implements the IEEE 802.1ag protocol in software. Software components of the protocol reside on the CP card 40 and on each line card 44. There is one instance of a CFM task 64 on each card type (i.e. main CP and each line card). The CFM task 64 handles the generation and transmission of the 802.1ag packets. In general, the CFM task 64 creates a MEP entity 68 when the CFM task 64 starts on a line card 44. Each line card has sufficient memory to support an MEP entity.

Line cards 44 with UNIs associated with NNI trunks keep a record of those NNI trunks and their trunk groups. The trunks of a given trunk group can span multiple cards. Trunks are marked as up and available for data traffic, or down. At a UNI, a trunk is valid only if there is an endpoint using that trunk. So when the data from the NNI trunk state is received, the UNI may be using that trunk. If the UNI is using that trunk, then the UNI update its internal records or trigger a trunk switch.

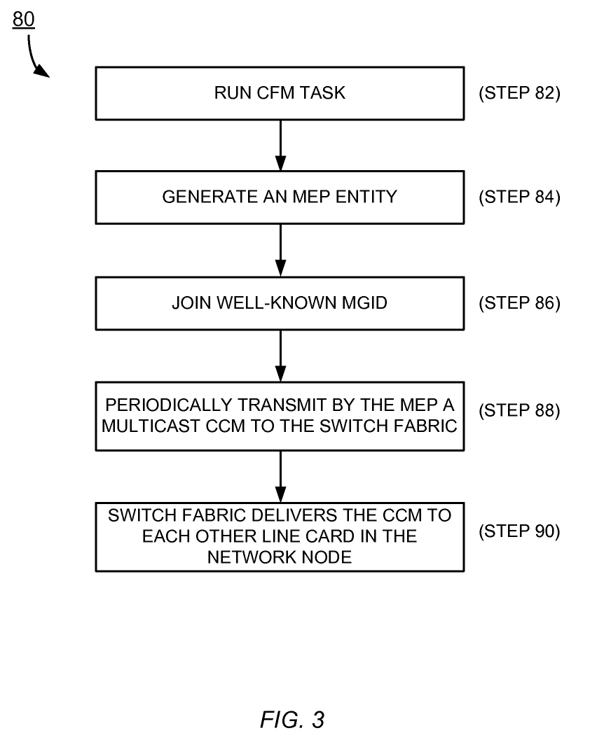

FIG. 3 shows an embodiment of a process 80 performed by each line card 44 upon initialization (and any subsequent re-initialization). In the description of the process 80, reference is also made to the FIG. 2. At step 82, each line card 44 runs its instance of the CFM task 64. When the CFM task 64 begins to execute on a given line card, that CFM task 64 generates (step 84) an MEP entity 68 (i.e., local internal MEP) on that line card. The MEP id of the internal MEP on any given line card is equal to the slot number of that line card. Values assigned to the MA and MD indices are invalid, but are provided so as not to interfere with the normal execution of the 802.1ag protocol running within the CFM task on the line card.

Each line card 44 in the network node 12 joins (step 86) a specific well-known Multicast Global Identifier (MGID) (e.g., 0x7F5). A multicast packet is sent to a multicast group. Internally, a packet that is transmitted to the group is forwarded to the members of that group. Specifically, each line card 44 has a pre-selected lane become a member of the well-known multicast group (i.e., using the well-known MGID number). Thus, when multicast packets are sent to this well-known MGID, the packet will be sent to all the line cards on its pre-selected lane. Because the CFM task has one instance per line card, getting to the pre-selected lane is sufficient to reach the CFM task. Further, CCM packets are sent as multicast packets. Thus, the internal MEP messages (i.e., CCM packets) are sent to the well-known MGID, and because only the line cards 44 have joined this MGID, these packets go only to the CFM task running on each line card for processing.

The MEP entity 68 on each line card 44 begins to transmit (step 88) CCM messages to the switch fabric 48. Each MEP entity 68 transmits such messages periodically based on when that MEP entity starts. The interval at which the MEP transmits messages is hardcoded (i.e. predetermined). In one embodiment, the interval is 10 ms. For proper operation according to the 802.1ag protocol, the interval is the same for all line cards 44. Other interval durations may be used without departing from the principles of the invention.

Each CCM message sent by a given line card are multicast (step 88) to the other line cards in the network node 12 and is transmitted on the specific well-known MGID. The well-known MGID ensures that the switch fabric delivers (step 90) CCMs issued by each line card to all other line cards in the network node 12 that have joined the MGID. Because every line card 44 generates an internal MEP, each line card can pair its local internal MEP with each of the remote internal MEPs on the other line cards. The program code of the CFM task 64 for receiving and processing CCM packets is the same protocol code that is used for local MEP/remote MEP pairs between boxes (i.e. separate chassis).

Through their internal MEPs, the line cards share state information. This sharing of information occurs using TLVs, which stands for “Type, Length, Value”. TLVs serve as a mechanism for encoding variable-length information in a PDU (protocol data unit); they are not aligned to any particular word boundary, and can follow each other without intervening padding. The IEEE 802.1ag standard enables the encoding of TLVs in the CCM messages, and allows organizations to define their own TLVs under the subtype of organizational specific. As described herein, two types of TLVs are defined: (1) a card-information TLV; and (2) a trunk status TLV.

Internal MEPs include a card-information TLV in each of its transmissions of a CCM. In general, a card-information TLV operates to inform a receiving line card that the sending line card is alive (i.e., as a hello between line cards). The card-information TLV provides data about the sender, namely, the slot number and card type of the sending line card. Receiving line cards can use this data to perform actions. Card-information TLVs and their usage remain internal to the box (i.e. network node).

### Card-Information TLVs

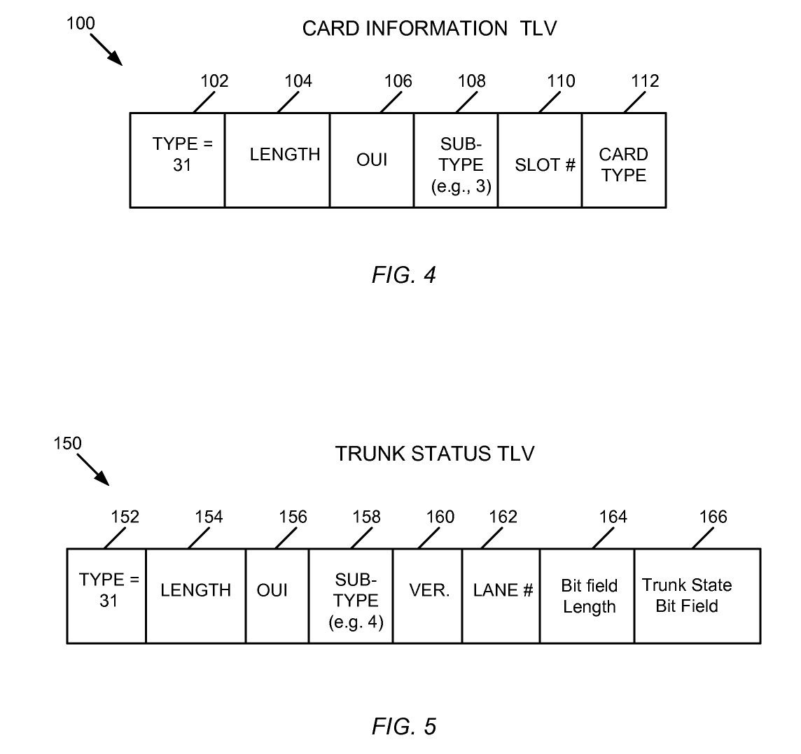

FIG. 4 shows an embodiment of a card-information TLV 100. The card-information TLV 100 includes a type field 102, a length field 104, an organizationally unique identifier (OUI) field 106, a sub-type field 108, a slot number field 110, and a card type field 112. In one embodiment, the type field 102 is one byte in size, the length field 104 is two bytes, the OUI field 106 is 3 bytes, the sub-type field 108 is one byte, the slot number field 110 is one byte, and the card type field 112 is one byte.

The type field 102 carries a value of 31 to signify that the TLV is an organizational-specific TLV (in conformance with IEEE 802.1ag). Organizational-specific TLVs in 802.1ag require certain fields for CCMs, such as the type, length, OUI, and sub-type fields; the other fields 110, 112 of the TLV are defined by the organization. The value in the length field 104 indicates the octet length of the card-information TLV. The OUI field 106 can hold any value—not being limited to the OUI assigned to the organization (e.g., Nortel Networks' assigned OUI is 0x000075)—because CCMs of the invention do not leave the chassis 20 to traverse the network 10. The sub-type field 108 enables an owner of an OUI to specify a plurality of different types of TLVs. Here, a sub-type value equal to 3 (as an example) indicates that this is a card-information TLV. This sub-type value is unique within the organization. The slot number field 110 indicates the particular slot 22 in the chassis 20 within which resides the line card that is sending the CCM.

The card type field 112 is used to specify which type of line card issued the CCM with the card-information TLV carried therein. The card type is specific to the application (i.e., model, type) of the network node 12. For example, some applications can have two or more types of line cards that transmit and receive CCMs, and the card type field 112 serves to distinguish among them.

### Trunk-Status TLVs

FIG. 5 shows an embodiment of a trunk-status TLV 150 used to propagate a list of trunk states instantiated on the line card that sends the CCM with a trunk-status TLV. In one embodiment, a given CCM can have as many as three trunk-status TLVs (i.e., one trunk-status TLV for each lane or RSP in the transmitting line card). The trunk-status TLV 150 includes a type field 152, a length field 154, an organizationally unique identifier (OUI) field 156, a sub-type field 158, a version field 160, a lane number field 162, a bit-field length field 164, and a trunk state bit field 166. In one embodiment, the type field, sub-type field, version field, and lane number field are each one byte in size, the length field and bit-length field are each two bytes, the OUI field is 3 bytes, and the trunk state bit field 166 is of variable length. In another embodiment, the type field, sub-type field, version field, and lane number field are each one byte in size, the length field and bit-length field are each two bytes, the OUI field is 3 bytes, and the trunk state bit field 166 is of fixed length (e.g., 188 bytes).

The type field 152 carries a value of 31 to signify that the TLV is an organizational-specific TLV (in accordance with IEEE 802.1ag). The sub-type field 158 here, as an example, holds a sub-type value equal to 4. This sub-type value uniquely identifies the TLV as a trunk-status TLV. The value in the length field 154 indicates the octet length of the TLV. Like the OUI field 106 of a card-information TLV 100, the OUI field 156 can hold any value because CCMs produced by internal MEPs do not leave the chassis 20. The version field 158 indicates whether the bit map carried in the trunk state bit field 166 is the same as (i.e., unchanged from) the previously sent trunk state bit field. In an alternative embodiment, if the trunk state has not changed from the previously sent CCM, the transmitting line card does not include a trunk-status TLV in the current CCM.

The lane number field 162 identifies the lane for which the following trunk state bit field 166 corresponds. The number of lanes in a trunk-status TLV depends upon the number of RSPs in the line card (one lane per RSP). As an example, an internal MEP on a line card with three lanes may produce three trunk-status TLVs with three sets of lane number and trunk state bit field information.

The value in the bit length field 164 indicates the number of bits in the trunk state bit field 166. Each bit of the trunk state bit field 166 maps to a given trunk of a given lane (i.e., to the index id on that given lane). The bit value carried by each bit in this bit field 166 indicates whether the corresponding trunk to which that bit maps is up or down (e.g., a 1 bit value indicates the trunk is up, and a 0 bit value indicates the trunk is down).

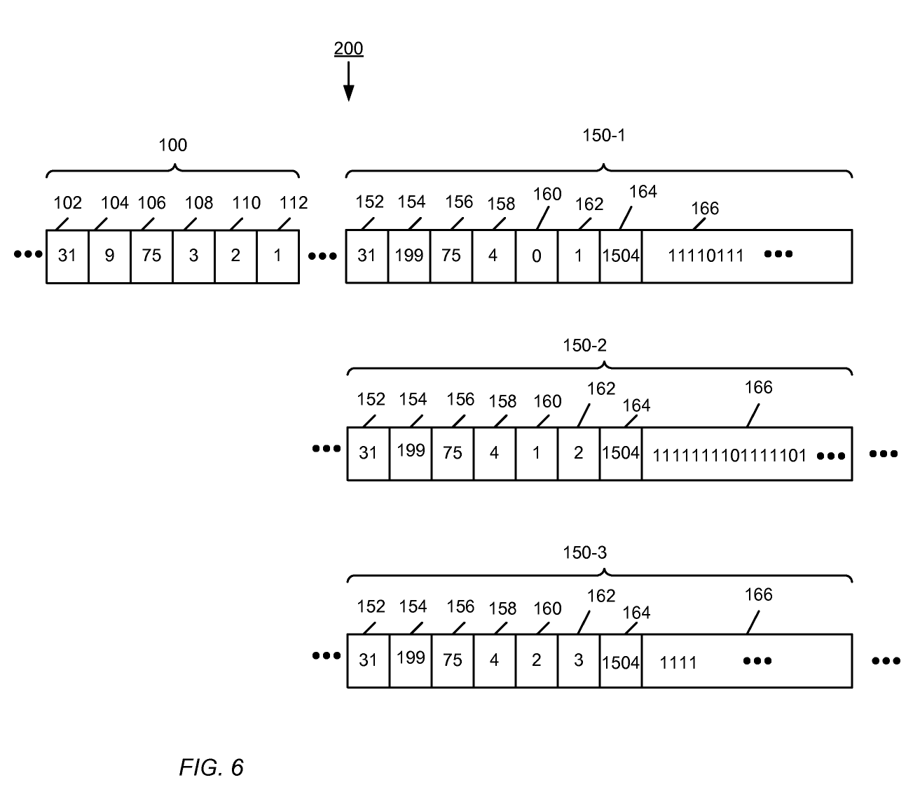

FIG. 6 shows a portion of a CCM 200 having a card-information TLV 100 and a plurality of fixed-length trunk-status TLVs 150-1, 150-2, 150-3. The ellipses shown in FIG. 6 signify that other data (e.g., TLVs) may come before, after, and between the card-information TLV 100 and the trunk-status TLVs 150-1, 150-2, 150-3. All values in the various fields of the TLVs 100, 150-1, 150-2, 150-3 are decimal values unless indicated otherwise.

Consider for purposes of this example that the CCM 200 originates from the line card 44-1, that line card 44-1 is in slot number 2, has three RSPs (i.e., three lanes), and is the first of three types of line cards in this particular model of network nodes. Also, consider that the first of the three RSPs has 8 trunks, the second RSP has 16 trunks, and the third RSP has 4 trunks. The number of trunks in each RSP is for illustration purposes only. In one embodiment, each RSP can support as many as 1504 trunks. In addition, the card-information TLV 100 is 9 bytes in length, and each trunk-status TLV 150-1, 150-2, 150-3 is 199 bytes in length.

In this example, the card-information TLV 100 has a value of 31 in the type field 102 signifying that this TLV is organizational specific. The value of 9 in the length field 104 indicates that the card-information TLV is 9 bytes in length. The hexadecimal value of 75 in the OUI field 106 identifies the organization. The sub-type value of 3 in the sub-type field 108 identifies the type of this TLV (the value of 3 being predetermined to signify a card-information TLV). The value of 2 in the slot number field 110 identifies the slot number of the card issuing this CCM 200. The value of 1 in the card type field 112 corresponds to a particular model of the line card 44-1.

Each trunk-status TLV 150-1, 150-2, 150-3 in this example has a value of 31 in the type field 152 signifying that this TLV is organizational specific. The value in the length field 154 indicates that the trunk-status TLV 150-1 is 199 bytes in length. The hexadecimal value of 75 in the OUI field 156 identifies the organization. The sub-type field 158 identifies the type of this TLV as a trunk-status TLV (the value of 4 being predetermined for this purpose).

The version field 160 of each trunk-status TLV serves to indicate whether the following trunk-state bit field 166 has changed. If a line card receives a trunk-status TLV with a version that is the same as the version in the most recently received and processed trunk-status TLV, the line card knows not to process the present trunk-status TLV. If the version has changed from the version in the trunk-status TLV in the most recently processed CCM, the code on the line card processes the trunk-state bit field 166 of present trunk-status TLV.

The first trunk-status TLV 150-1 has a value of 1 in the lane number field 162 to identify the first lane of the line card 44-1. The bit length field 164 for the first lane has a value of 1504 to indicate that the following trunk-state bit field (or bitmap) 166 is 1504 bits in length (i.e., the lane can support as many as 1504 trunks). In this example, the first lane is presently supporting eight trunks. The states of these eight trunks are represented by the first eight bits in the trunk-state bit field 166 (although not shown, each of the remaining 1496 bits in the bit field 166 has a 0 bit value). The trunk-state bit field 166 of the first lane indicates that, of the eight associated trunks, all but the 5^{th} trunk (counting from the left) are operational (up). More specifically, the 5^{th} bit in the trunk-state bit field 166 maps to a particular index id (i.e., a particular trunk of the lane), and has a value equal to 0 to indicate that the particular trunk is down.

The second trunk-status TLV 150-2 has a value of 2 in the second lane number field 162 to identify the second lane of the line card 44-1. The bit length field 164 for the second lane has a value of 1504 to indicate that the following trunk-state bit field 166 is 1504 bits in length (in fixed length trunk-status TLVs, the lengths of the trunk-state bit fields 166 of the trunk-status TLVs 150-1, 150-2, 150-3 are the same). In this example, the second lane is presently supporting 16 trunks, and the first 16 bits in the trunk-state bit field 166 represent the states of these 16 trunks. Each of the remaining 1488 bits (not shown) in the bit field 166 has a 0 bit value, indicating that such “trunks” are down, although such bits are not actually associated with a particular trunk. The trunk-state bit field 166 of the second lane indicates that, of the 16 associated trunks, all but the 9^{th} and 15^{th} trunks (counting from the left) are operational (up). Conversely, trunks corresponding to bitmap locations 9 and 15 are in a down state.

The third trunk-status TLV 150-3 has a value of 3 in the second lane number field 162 to identify the third lane of the line card 44-1. The bit length field 164 for the third lane has a value of 1504 to indicate that the following trunk-state bit field 166 is 1504 bits in length. In this example, the third lane is presently supporting four trunks, are represented by the first four bits in the trunk-state bit field 166. Each of the remaining 1500 bits in the bit field 166 has a 0 bit value. The trunk-state bit field 166 of the third lane indicates that all four presently supported trunks are operational (up). Although, the 1500 remaining bits in the trunk-state bit field 166 are unassociated with any particular trunk, the 0 bit values assigned to these bits, in effect, indicate that these “trunks” down.

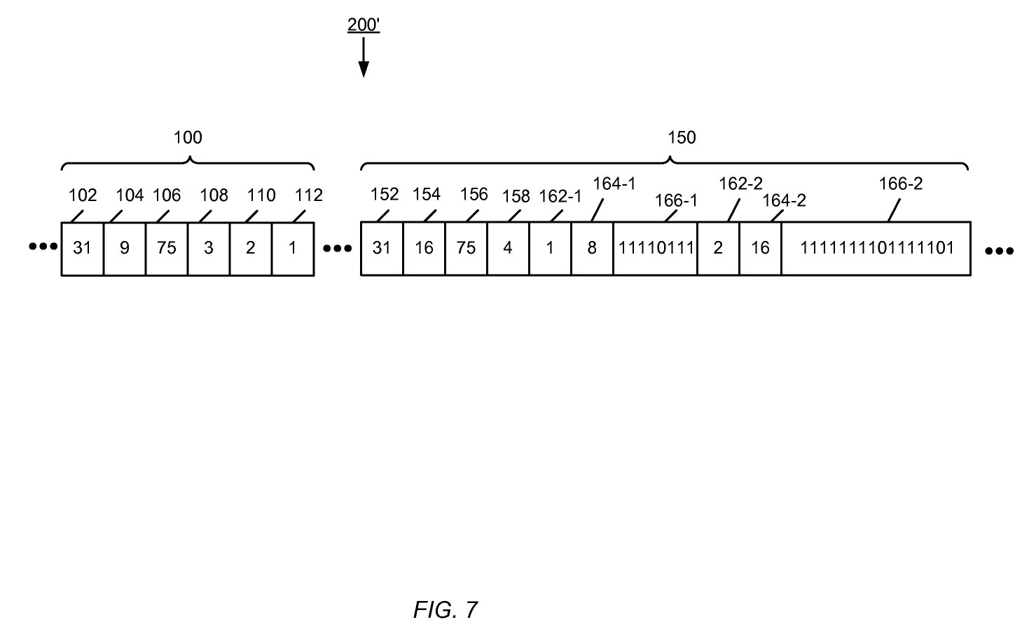

FIG. 7 shows an example of a portion of a CCM 200′ having a card-information TLV 100 and a variable-length trunk-status TLV 150. In this example embodiment, a single trunk-status TLV 150 carries the trunk-state bitmaps of all lanes of the line card (in contrast to one trunk-status TLV for each lane, as described in FIG. 6). The ellipses shown in FIG. 7 signify that other data may come before, after, and between the card-information and trunk-status TLVs 100, 150. All values in the various fields of the TLVs 100, 150 are decimal values unless indicated otherwise.

Consider for purposes of this example that the CCM 200′ originates from the line card 44-1, that line card 44-1 is in slot number 2, has two RSPs (i.e., two lanes), and is the first of three types of line cards in this particular model of network nodes. Also, consider that one of the two RSPs has 8 trunks and the other RSP has 16 trunks. In addition, the card-information TLV 100 is 9 bytes in length, and the trunk-status TLV is 16 bytes in length.

In this example, the contents of the card-information TLV 100 are the same as those of the card-information TLV 100 of the CCM 200 (FIG. 6), and are not repeated here for the sake of brevity.

The trunk-status TLV 150 in this example has a value of 31 in the type field 152 signifying that this TLV is organizational specific. The value in the length field 154 indicates that the trunk-status TLV is 16 bytes in length. The hexadecimal value of 75 in the OUI field 156 identifies the organization. The sub-type field 158 identifies the type of this TLV as a trunk-status TLV (the value of 4 being predetermined for this purpose). In this example, the version field 160 is omitted—the presence itself of the trunk-status TLV 150 in the CCM 200 signifying that trunk state changes have occurred since the previously sent CCM.

The first lane number field 162-1 has a value of 1 to identify the first lane of the line card 44-1. In this example, the first lane has 8 associated trunks. The states of these eight trunks can be represented by eight bits. Accordingly, the bit length field 164-1 for the first lane has a value of 8 to indicate that the following trunk bitmap is 8 bits in length. The trunk-state bit field 166-1 of the first lane indicates that all but the 5^{th} trunk (counting from the left) are operational (up). More specifically, the 5^{th} bit in the trunk-state bit field 166-1 maps to a particular index id (i.e., a particular trunk of the lane), and has a value equal to 0 to indicate that the particular trunk is down.

The second lane number field 162-2 has a value of 2 to identify the second lane of the line card 44-1. In this example, the second lane has 16 associated trunks. The bit length field 164-2 for the second lane has a value of 16 to indicate that the following trunk bitmap is 16 bits in length. The trunk-state bit field 166-2 of the second lane indicates that all but the 9^{th} and 15^{th} trunks (counting from the left) are operational (up). Conversely, trunks corresponding to bitmap locations 9 and 15 have transitioned to a down state.

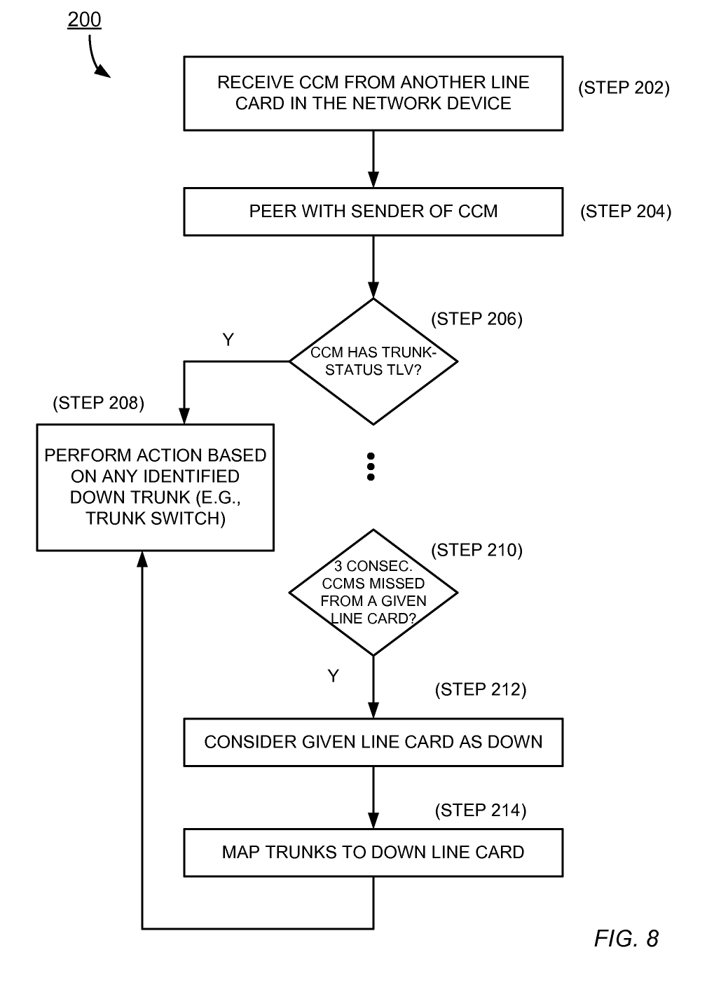

FIG. 8 shows an embodiment of a process 200 performed by each line card 44 based on CCMs received or not received from the other line cards in the network node 12. At step 202, the CFM task 64 of a given line card 44 receives a CCM packet sent by the MEP entity of another line card in the network node. A bit set in the preamble of the CCM packet indicates that the receive packet is an internal MEP message. The CFM task 64 searches for its local internal MEP and peers (step 204) with the remote internal MEP that sent the received CCM. Accordingly, the given line card can know the state of the other line cards based on whether the local internal MEP/remote MEP pair with each of the other line cards is in an UP state.

Each line card maintains a record of when that line card last received a CCM from each of the other line cards. From the slot number value in the card-information TLV, a receiver of a CCM can determine which line card sent the message. Accordingly, receipt of a CCM from a given line card indicates that the local internal MEP/remote MEP pair with that line card is currently in an UP state. In addition, the line card that receives a CCM can perform different actions depending on the type of the sending line card. The receiving line card can determine the type of the line card that sent the CCM based on the value in the card type field 112.

If, at step 206, a received CCM contains a trunk-status TLV, and the trunk-status TLV identifies a trunk that has gone down, the line card can initiate (step 208) an action based on the down trunk. For example, if the down trunk is a primary trunk, the line card can initiate a trunk switchover to the secondary trunk.

If, at step 210, a period elapses during which the local internal MEP of the line card misses three consecutive CCMs from the remote internal MEP of a given line card, the local internal MEP considers (step 212) the remote internal MEP of the given line card to have gone down (e.g., because the given line card failed or was removed from the chassis). Because each line card maintains a record of its trunks and their trunk groups, when a line card detects that another line card is down, that line card knows that all of the trunks that mapped to the down line card can be internally converted to individual trunk down events. The line card thus determines (step 214) which trunks were supported by the down line card. If any of the trunks supported by the down card had been the primary trunk of a trunk group, then the line card initiates an action (step 208), such as a trunk switchover to the secondary trunk. This saves time to initiate the switching of (e.g., PBB-TE) trunks on the network node.

Aspects of the present invention may be embodied in hardware (digital or analog), firmware, software (i.e., program code), or a combination thereof. Program code may be embodied as computer-executable instructions on or in one or more articles of manufacture, or in or on computer-readable medium. Examples of articles of manufacture and computer-readable medium in which the computer-executable instructions may be embodied include, but are not limited to, a floppy disk, a hard-disk drive, a CD-ROM, a DVD-ROM, a flash memory card, a USB flash drive, an non-volatile RAM (NVRAM or NOVRAM), a FLASH PROM, an EEPROM, an EPROM, a PROM, a RAM, a ROM, a magnetic tape, or any combination thereof. The computer-executable instructions may be stored as, e.g., source code, object code, interpretive code, executable code, or combinations thereof. Generally, any standard or proprietary, programming or interpretive language can be used to produce the computer-executable instructions. Examples of such languages include C, C++, Pascal, JAVA, BASIC, Visual Basic, and C#. A computer, computing system, or computer system, as used herein, is any programmable machine or device that inputs, processes, and outputs instructions, commands, or data.

While the invention has been shown and described with reference to specific preferred embodiments, it should be understood by those skilled in the art that various changes in form and detail may be made therein without departing from the spirit and scope of the invention as defined by the following claims. For example, instead of or in addition to card-information TLVs and trunk-status TLVs, other types of TLVs for sharing any data among the cards can be defined. As an example, a port-status TLV can be used to share port state information among line cards.

What is claimed is:

1. A network node for use in a communications network, comprising:
a central processor (CP) card;
a switch fabric; and
a plurality of line cards, each line card being in communication with the CP card and with each other line card through the switch fabric, each line card having a maintenance association end point (MEP) entity that responds to connectivity fault management (CFM) frames, the MEP entity of each line card being configured to generate and transmit a multicast connectivity check message (CCM) periodically to the other line cards in the network node through the switch fabric.

2. The network node of claim 1, wherein each transmitted CCM has a TLV (Type Length Value) by which the line card transmitting the CCM shares information with each of the other line cards in the network node.

3. The network node of claim 2, wherein the TLV is a card-information TLV that includes a slot number of the line card transmitting the CCM.

4. The network node of claim 2, wherein the TLV includes at least one trunk-status TLV that provides an up or down status of the trunks supported by the line card transmitting the CCM.

5. The network node of claim 4, wherein each trunk is a PBB-TE (Provider Backbone Bridge Traffic Engineering) trunk.

6. The network node of claim 2, wherein the TLV is a card-information TLV that includes a slot number of the line card transmitting the CCM, and wherein the transmitted CCM further includes at least one trunk-status TLV that provides an up or down status of the trunks supported by the line card transmitting the CCM.

7. The network node of claim 1, wherein the MEP entity of each line card considers a given line card to be down if the MEP entity of that line card does not receive a CCM from the MEP entity of the given line card during a period corresponding to three consecutive CCM transmissions.

8. The network node of claim 7, wherein each line card identifies at least one trunk that is down in response to determining that the given line card is down.

9. The network node of claim 1, wherein each line card maintains a mapping of trunks to the line cards supporting those trunks, a first line card of the line cards determining that a given line card is down, identifying each trunk mapped to the down line card, and performing an action for each trunk mapped to the down line card equivalent to an action that the first line card would take if the first line card had received a trunk-status TLV identifying as down each trunk that maps to the down line card.

10. The network node of claim 9, wherein the action includes initiating, by the first line card, a trunk switch for a trunk supported by the first line card that maps to the down line card.

11. A method of communication among line cards in a network node, the method comprising:
generating, on each line card of a plurality of line cards in the network node, a maintenance association end point (MEP) entity that responds to connectivity fault management (CFM) frames; and
periodically generating and transmitting, by the MEP entity on each line card, a multicast connectivity check message (CCM) to the other line cards in the network node.

12. The method of claim 11, further comprising embedding, by a given one of the line cards, a TLV (Type Length Value) in a CCM transmitted by that given line card for sharing information with each of the other line cards.

13. The method of claim 12, wherein the TLV is a card-information TLV that includes a slot number of the given line card.

14. The method of claim 12, wherein the TLV includes at least one trunk-status TLV that provides an up or down status of the trunks supported by the given line card.

15. The method of claim 14, wherein each trunk is a PBB-TE (Provider Backbone Bridge Traffic Engineering) trunk.

16. The method of claim 12, wherein the TLV is a card-information TLV that provides information about the given line card, and further comprising embedding, by the given line card, a second TLV in the CCM, the second TLV including at least one trunk-status TLV that provides an up or down status of the trunks supported by the given line card.

17. The method of claim 11, further comprising determining, by a first line card of the plurality of line cards, that a given line card is down if the first line card does not receive a CCM from the given line card for a period corresponding to three consecutive CCM transmissions.

18. The method of claim 17, further comprising identifying, by the first line card, at least one trunk that is down in response to determining that the given line card is down.

19. The method of claim 11, further comprising:
maintaining, by each line card, a mapping of trunks to line cards supporting those trunks;
determining, by a first one of the line cards, that another line card is down; and
identifying, by the first one of the line cards, each trunk mapped to the down line card; and
performing an action for each trunk mapped to the down line card equivalent to an action that the first line card would take if the first line card had received a trunk-status TLV identifying as down each trunk that maps to the down line card.

20. The method of claim 19, wherein the action includes initiating, by the first line card, a trunk switch for a trunk supported by the first line card that maps to the down line card.
